(19) United States
(12) Patent Application Publication
(10) Pub. No.: US 2004/0181386 A1
(43) Pub. Date: Sep. 16, 2004

(54) Method of designing semiconductor device allowing control of current driving capability depending on shape of element forming region

(75) Inventor: Toshifumi Iwasaki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Renesas Technology Corp., TOKYO (JP)

(21) Appl. No.: 10/650,797

(22) Filed: Aug. 29, 2003

(30) Foreign Application Priority Data
Mar. 14, 2003 (JP) 2003-069692

(51) Int. Cl. G06F 17/50

(52) U.S. Cl. 703/14

(57) ABSTRACT

A method of designing an MOSFET of the present invention is concerned with design of a photomask which is used in a patterning process for forming an element isolation insulating film. An element forming region includes in top view a projecting portion (8a, 8b) along its perimeter. With respect to the structure in which the projecting portion (8a, 8b) is not provided, stress exerted on a semiconductor substrate (1) from an element isolation insulating film (2) varies. Provision of the projecting portion (8a, 8b) thus allows fine control of stress exerted on an area of the semiconductor substrate (1) holding a gate structure (3) thereover. As a result, the current driving capability of an MOSFET can be controlled at a desirable level.

### BACKGROUND OF THE INVENTION

1. Field of the Invention

The present invention relates to a method of designing a semiconductor device, and more particularly, it relates to a method of designing an MOSFET allowing fine control of a current driving capability.

2. Description of the Background Art

In a conventional method of designing an MOSFET, a current driving capability is controlled according to a distance between a contact plug and a gate electrode, an exemplary technique of which is introduced in Japanese Patent Application Laid-Open No. 11-186495 (1999) (FIGS. 3 and 4).

In such conventional method, a source/drain region should be provided with a portion largely projecting in a direction perpendicular to the extending direction of a gate electrode. This causes reduction in integration level.

### SUMMARY OF THE INVENTION

It is an object of the present invention to obtain a method of designing a semiconductor device allowing fine control of a current driving capability, while avoiding reduction in integration level, or bringing such reduction under control.

According to the present invention, the semiconductor device to be designed includes a semiconductor substrate, an element isolation insulating film, a gate structure, and source/drain regions. The element isolation insulating film is provided in a part of a main surface of the semiconductor substrate. The gate structure is provided on a part of the main surface of the semiconductor substrate. The gate structure is placed in an element forming region defined by the element isolation insulating film. The source/drain regions are provided in the main surface of the semiconductor substrate in the element forming region. The source/drain regions form a pair while holding a channel forming region defined under the gate structure therebetween. Depending on a shape of the element forming region, stress is controlled which is exerted on an area of the semiconductor substrate holding the gate structure thereover.

The current driving capability of the semiconductor device can be controlled at a desirable level, while avoiding reduction in integration level, or bringing such reduction under control.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B illustrate a structure of an MOSFET according to a first preferred embodiment of the present invention;

FIG. 2 is a sectional view taken along a cutting line II-II in FIG. 1A;

FIGS. 3A and 3B, 4A and 4B, and 5A and 5B each illustrate a structure of an MOSFET according to a modification of the first preferred embodiment of the present invention;

FIGS. 6A and 6B illustrate a structure of an MOSFET according to a second preferred embodiment of the present invention; and

FIGS. 7A and 7B illustrate a structure of an MOSFET according to a third preferred embodiment of the present invention.

### DESCRIPTION OF THE PREFERRED EMBODIMENTS

The present invention relates to a method of designing a semiconductor device, especially to a method of designing a photomask used in a patterning process for forming an element isolation insulating film. With reference to an MOSFET as an example, the preferred embodiments of the present invention will be discussed below.

### First Preferred Embodiment

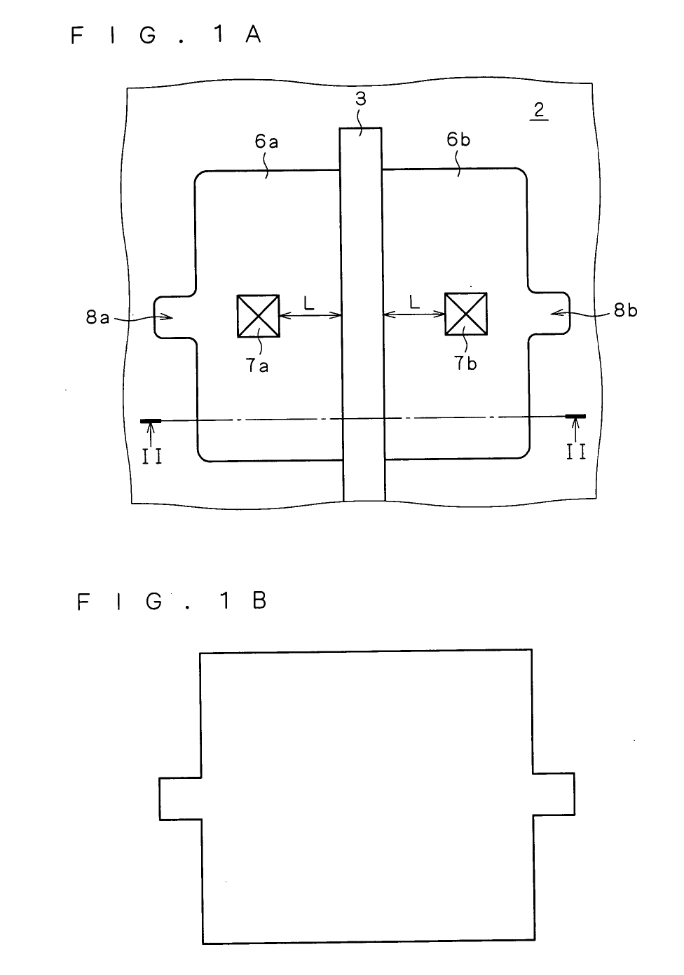

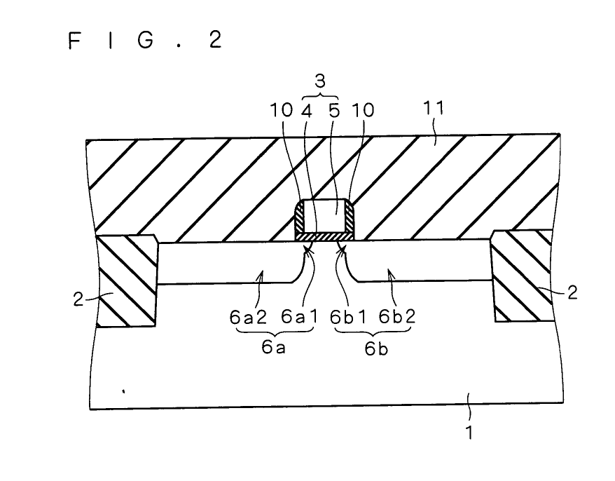

FIGS. 1A and 1B illustrate a structure of an MOSFET according to a first preferred embodiment of the present invention. A top view of the MOSFET is shown in FIG. 1A. FIG. 1B shows an opening pattern of a photomask used in a patterning process for forming an element isolation insulating film 2 shown in FIG. 1A. FIG. 2 is a sectional view taken along a cutting line II-II in FIG. 1A. In FIG. 1A, an interlayer insulating film 11 included in FIG. 2 is omitted.

With reference to FIG. 2, the MOSFET has a semiconductor substrate 1 containing silicon, the element isolation insulating film 2 containing silicon oxide, a gate structure 3, and a pair of source/drain regions 6a and 6b. The element isolation insulating film 2 is provide in a part of an upper surface of the semiconductor substrate 1. In an element forming region defined by the element isolation insulating film 2, the gate structure 3 is provided on a part of the upper surface of the semiconductor substrate 1. The gate structure 3 includes a gate insulating film 4 containing silicon oxide, and a gate electrode 5 containing doped polysilicon. A sidewall 10 containing silicon nitride is provided on side surfaces of the gate electrode 5.

The source/drain regions 6a and 6b are provided in the upper surface of the semiconductor substrate 1 in the element forming region. The source/drain regions 6a and 6b are opposite to each other through a channel forming region defined under the gate structure 3. The source/drain region 6a has a first impurity-introduced region 6a1 reaching a relatively shallow depth, and a second impurity-introduced region 6a2 reaching a relatively great depth. The source/drain region 6b has a first impurity-introduced region 6b1 reaching a relatively shallow depth, and a second impurity-introduced region 6b2 reaching a relatively great depth. The interlayer insulating film 11 containing silicon oxide is provided to cover the MOSFET and the element isolation insulating film 2. The materials described so far are merely exemplary. Each component may contain alternative material. The structure of the MOSFET is also merely exemplary. Any alternative structure may be applicable.

When the element isolation insulating film 2 is a trench type film as shown in FIG. 2, the method of forming the element isolation insulating film 2 includes: (a) the step of providing a silicon oxide film and a silicon nitride film in this order on the semiconductor substrate 1; (b) the step of patterning the silicon nitride film; (c) the step of etching using the patterned silicon nitride film as an etching mask to create a recess in the semiconductor substrate 1; and (d) the step of filling the recess with a silicon oxide film.

When the element isolation insulating film 2 is an LOCOS type film, the method of forming the element isolation insulating film 2 includes: (a) the step of providing a silicon oxide film and a silicon nitride film in this order on the semiconductor substrate 1; (b) the step of patterning the silicon nitride film; and (c) the step of thermally oxidizing the semiconductor substrate 1 where the silicon nitride film dose not exist.

With reference to FIG. 1A, the element forming region is provided with projecting portions 8a and 8b. Namely, the element forming region includes in top view the projecting portions 8a and 8b along its perimeter. In the process of patterning the silicon nitride film performed in the foregoing step (b) of forming the element isolation insulating film 2, photolithography is performed using a photomask having the opening pattern shown in FIG. 1B, whereby the element forming region provided with the projecting portions 8a and 8b is obtained.

The photomask having the opening pattern of FIG. 1B is defined by corners each having an angle of 90 degrees. In contrast, each corner of the element forming region shown in FIG. 1A is slightly rounded. This rounding is caused by proximity effect occurring in exposure of a photoresist formed on the silicon nitride film in the foregoing step (b) of forming the element isolation insulating film 2.

With reference to FIG. 1A, the MOSFET has contact plugs 7a and 7b. The contact plugs 7a and 7b are connected to source/drain regions 6a and 6b, respectively, each with a predetermined distance L (of a fixed value) from the gate structure 3. The contact plugs 7a and 7b are provided in the interlayer insulating film 11 shown in FIG. 2, and respectively on the source/drain regions 6a and 6b where the projecting portions 8a and 8b are not provided.

As seen from FIG. 1A, the element forming region includes in top view the projecting portions 8a and 8b along its perimeter. With respect to the structure in which the projecting portions 8a and 8b are not provided, stress exerted on the semiconductor substrate 1 from the element isolation insulating film 2 varies accordingly. The current driving capability of the MOSFET varies according to the intensity of stress exerted on an area of the semiconductor substrate 1 holding the gate structure 3 thereover. In view of this, in the method of designing an MOSFET of the first preferred embodiment, provision of the projecting portions 8a and 8b allows fine control of the stress exerted on the area of the semiconductor substrate I holding the gate structure 3 thereover. As a result, the current driving capability of the MOSFET can be controlled at a desirable level.

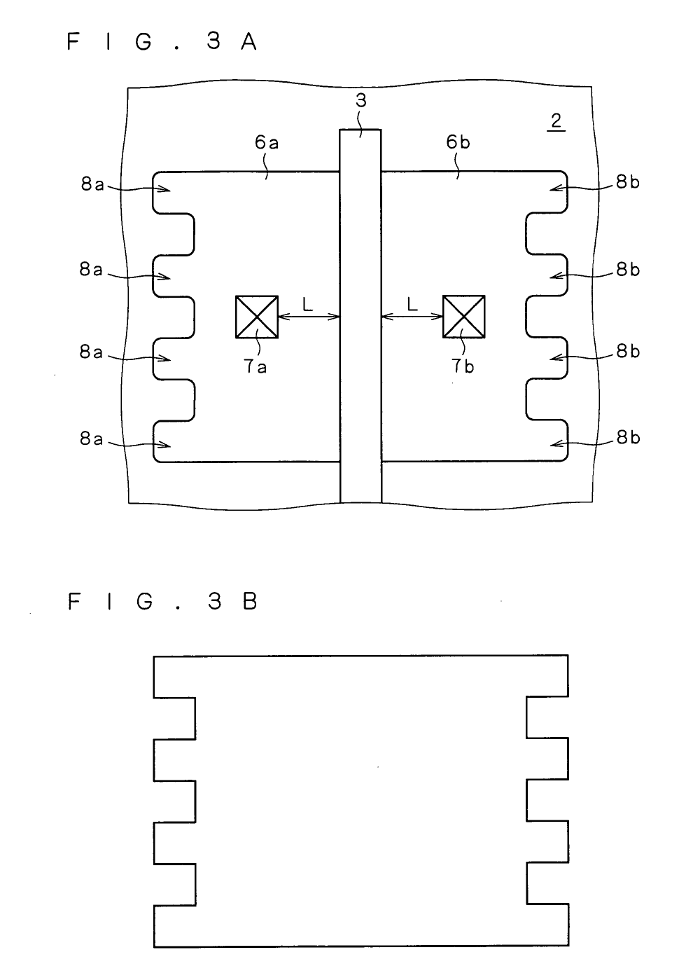

FIGS. 3A and 3B, 4A and 4B, and 5A and 5B each illustrate a structure of an MOSFET according to a modification of the first preferred embodiment. Top views of the MOSFETs are shown in FIGS. 3A, 4A and 5A. FIGS. 3B, 4B and 5B show opening patterns of photomasks used in a patterning process for forming the element isolation insulating film 2 shown in FIGS. 3A, 4A and 5A, respectively.

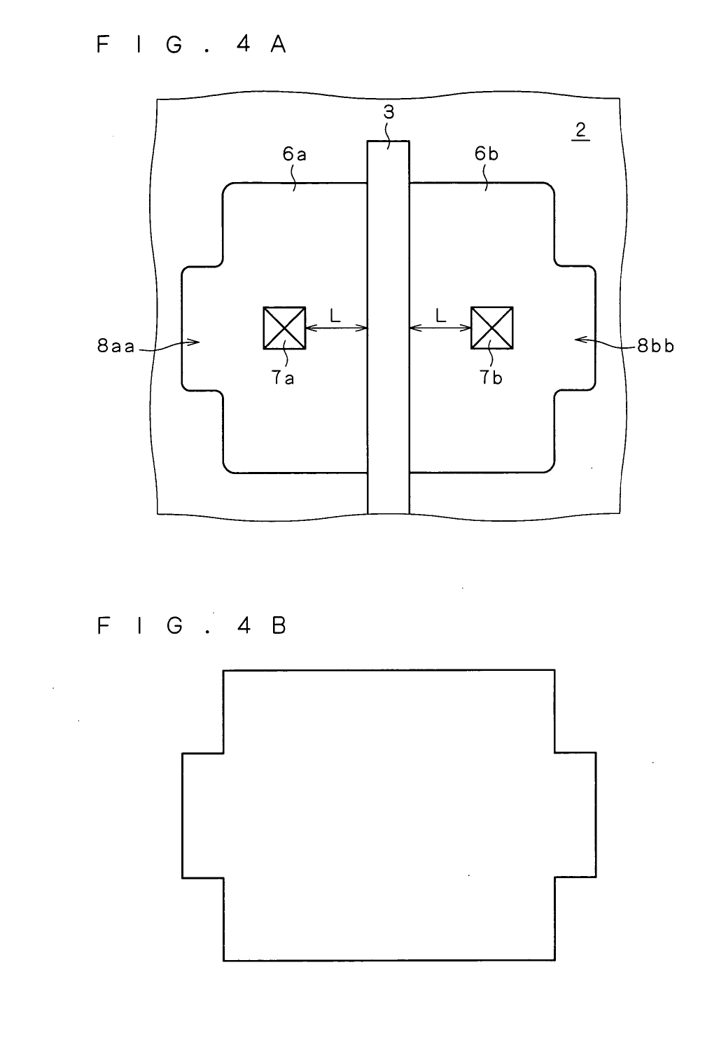

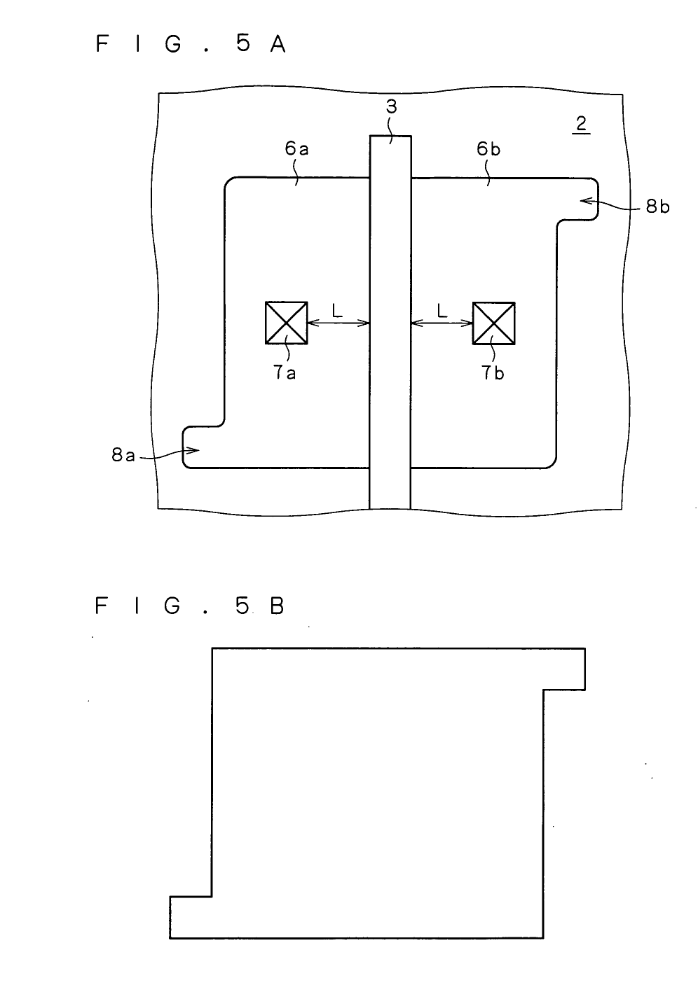

The projecting portion 8a may include a plurality of portions 8a, and the projecting portion 8b may include a plurality of portions 8b, as shown in FIG. 3A. Alternatively, the projecting portion 8a and 8b may be greater in size in the extending direction of the gate structure 3, which are respectively referred to as projecting portions 8aa and 8bb in FIG. 4A. Still alternatively, the projecting portions 8a and 8b may be provided at respective corners of the source/drain regions 6a and 6b, as shown in FIG. 5A. With reference to FIGS. 1A, 3A, 4A and 5A, among four sides defining the perimeter of the element forming region, the projecting portions 8a and 8b, or 8aa and 8bb, are provided along the sides extending in a direction parallel to the extending direction of the gate structure 3. Alternatively, the projecting portions 8a and 8b, or 8aa and 8bb, may be along the side extending in a direction perpendicular to the extending direction of the gate structure 3.

Those structures of the modifications provide increase or reduction in intensity of the stress exerted on the area of the semiconductor substrate 1 holding the gate structure 3 thereover, as compared with the stress intensity exhibited in the structure shown in FIG. 1A. With respect to the structure of FIG. 1A, the current driving capability of the MOSFET is allowed to vary accordingly.

Excessive increase in area covered by the projecting portion 8 (including 8a, 8b, 8aa and 8bb) causes reduction in integration level of a semiconductor device. In order to bring the reduction in integration level under control, the size and the number of the projecting portion 8 are desirably adjusted in such a manner that the total area covered by the projecting portion 8 is 30% or less, for example, of the area covered by the element forming region in which the projecting portion 8 is not provided.

### Second Preferred Embodiment

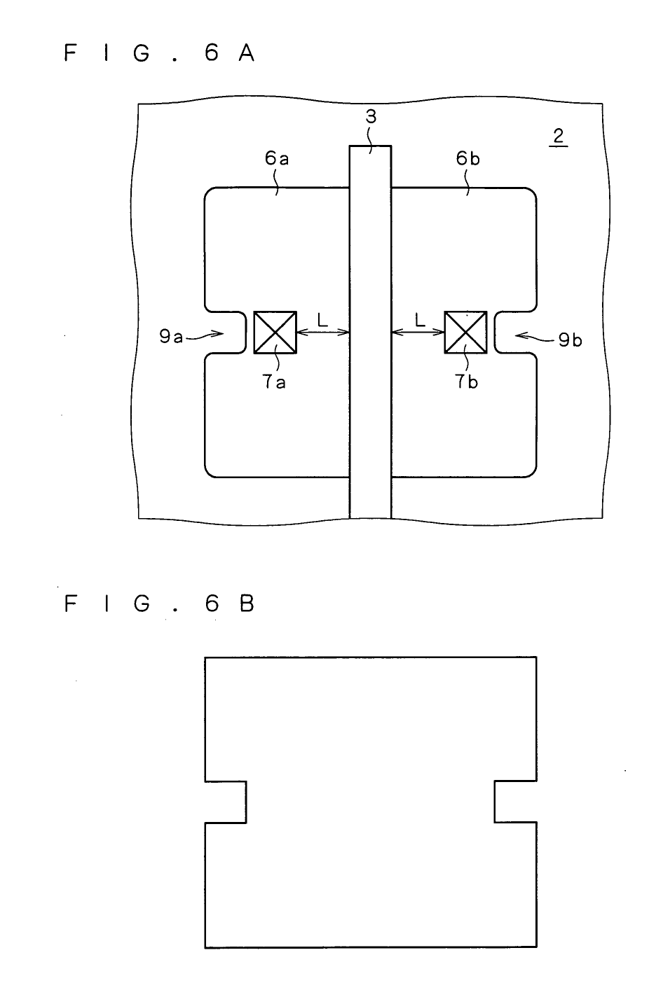

FIGS. 6A and 6B illustrate a structure of an MOSFET according to a second preferred embodiment of the present invention. A top view of the MOSFET is shown in FIG. 6A. FIG. 6B shows an opening pattern of a photomask used in a patterning process for forming the element isolation insulating film 2 shown in FIG. 6B.

In the element forming region, the projecting portions 8a and 8b of FIG. 1A are replaced by recessed portions 9a and 9b. Namely, the element forming region includes in top view the recessed portions 9a and 9b along its perimeter. Similar to the modifications shown in FIGS. 3A and 3B, 4A and 4B, and 5A and 5B, the number, size, and the location of the recessed portions 9a and 9b may be arbitrarily changed.

Similar to the projecting portions 8a and 8b, provision of the recessed portions 9a and 9b also allows the stress to vary which is exerted on the semiconductor substrate 1 from the element isolation insulating film 2, with respect to the structure in which the recessed portions 9a and 9b are not provided. That is, similar to the method of the first preferred embodiment, the method of designing an MOSFET according to the second preferred embodiment also allows the current driving capability of the MOSFET to be controlled at a desirable level.

In contrast to the projecting portions 8a and 8b, the recessed portions 9a and 9b do not cause increase in area of the element forming region, whereby reduction in integration level can be avoided.

### Third Preferred Embodiment

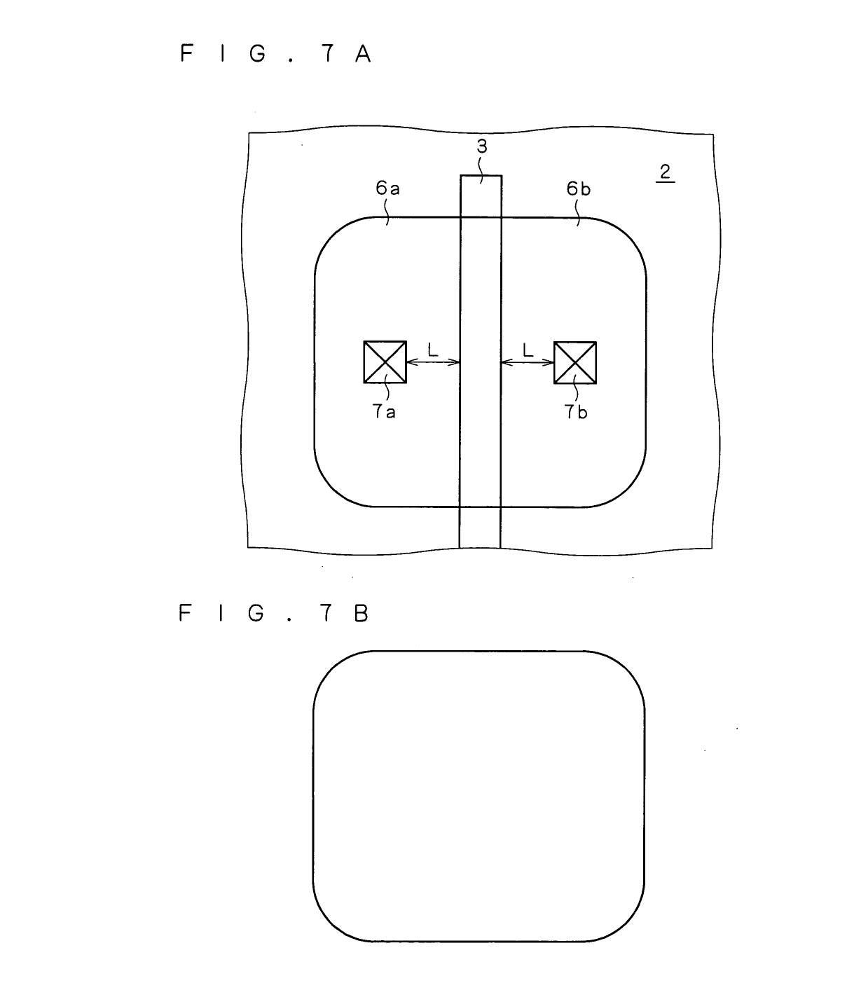

FIGS. 7a and 7b illustrate a structure of an MOSFET according to a third preferred embodiment of the present invention. A top view of the MOSFET is shown in FIG. 7A. FIG. 7B shows an opening pattern of a photomask used in a patterning process for forming the element isolation insulating film 2 shown in FIG. 7A.

In a patterning process of the third preferred embodiment for forming the element isolation insulating film 2, a conventional photomask having a rectangular opening pattern is replaced by a photomask having an opening pattern with rounded corners as shown in FIG. 7B. As a result, as seen from FIG. 7A, the corners of the element forming region are greater in curvature than the corners of an element forming region which is defined by using a photomask having a rectangular opening pattern (see FIG. 1A, for example).

Similar to the projecting portions 8a and 8b, change in curvature of the corners of the element forming region also allows the stress to vary which is exerted on the semiconductor substrate 1 from the element isolation insulating film 2. That is, similar to the method of the first and second preferred embodiments, the method of designing an MOSFET according to the third preferred embodiment also allows the current driving capability of the MOSFET to be controlled at a desirable level.

In contrast to the projecting portions 8a and 8b, change in curvature of the corners of the element forming region does not cause increase in area of the element forming region, whereby reduction in integration level can be avoided.

While the invention has been shown and described in detail, the foregoing description is in all aspects illustrative and not restrictive. It is therefore understood that numerous modifications and variations can be devised without departing from the scope of the invention.

What is claimed is:

1. A method of designing a semiconductor device, said semiconductor device to be designed comprising:
a semiconductor substrate;
an element isolation insulating film provided in a part of a main surface of said semiconductor substrate;
a gate structure provided on a part of said main surface of said semiconductor substrate, said gate structure being placed in an element forming region defined by said element isolation insulating film; and
source/drain regions provided in said main surface of said semiconductor substrate in said element forming region, said source/drain regions forming a pair holding a channel forming region defined under said gate structure therebetween, wherein
stress exerted on an area of said semiconductor substrate is controlled depending on a shape of said element forming region, said area of said semiconductor substrate holding said gate structure thereover.

2. The method according to claim 1, wherein
said element forming region includes in top view at least one projecting portion provided along a perimeter of said element forming region.

3. The method according to claim 1, wherein
said element forming region includes in top view at least one recessed portion provided along a perimeter of said element forming region.

4. The method according to claim 1, wherein
in top view, a corner of said element forming region is greater in curvature than a corner of an element forming region defined by an element isolation insulating film which is formed by a patterning process using a photomask having a rectangular opening pattern.
